(19) United States
(12) Patent Application Publication
(10) Pub. No.: US 2013/0314226 A1
(43) Pub. Date: Nov. 28, 2013

(54) METHOD AND SYSTEM USING MOBILE COMMUNICATION DEVICE TO IMPROVE HOME SAFETY

(71) Applicant: Wei Zhang, Newtown, PA (US)

(72) Inventor: Wei Zhang, Newtown, PA (US)

(21) Appl. No.: 13/478,033

(22) Filed: May 22, 2012

(51) Int. Cl. G08B 21/18; G08B 1/08

(52) U.S. Cl. 340/539.11; 340/539.1

(57) ABSTRACT

In accordance with the invention, a mobile communication device (MCD), preferable a mobile phone, intercepts a RF signal indicating a remote operation occurred on home equipment and starts safety monitoring process to observe situation progress following receiving the RF signal. When certain condition, for example time-up of a timer or leaving-site based on GPS location, is found satisfied, the MCD alerts user that a potential safety concern is raised up and prompts user to take appropriate action to prevent the potential safety concern from evolving into really occurred danger or disaster. The RF signal may be sent by a remote control or a remote sensing device coupled with operation of home equipment. Two examples respectively for safety enhancement of using cooking range and safety enhancement of accessing garage door are disclosed as implementation examples of the method and system using MCD to enhance home safety.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention generally relates to method and system of using mobile communication device, for example a mobile phone, to improve home safety, and in particular, to using a mobile communication device to accept RF (Radio Frequency) signal sent by home appliance component having status sensor incorporated therewith and to alert user for potential safety issue following the acknowledgement of the RF signal.

### BACKGROUND OF THE INVENTION

Mobile phone especially smart phone is playing more and more significant role in person's daily activities. Computing power contained by such mobile device enables many potential uses. Further considering facts that most people carry mobile phones no matter where they go, it is very ideal to use mobile phone to remind people with all kinds of information such as news, contact update, multimedia, and so on. Although there are many such applications that have been implemented or under development for implementation, it is certainly desirable for commonwealth of society and communities to investigate new or full potentials of using mobile communication device, such as mobile phone or other devices, to enhance safety of daily livings, for example home safety.

The information disclosed in this Background of the Invention section is for enhancement of understanding the background of the invention, and should not be taken as an acknowledgment or any form of suggestion that this information forms a prior art that would already be known to a person skilled in the art.

### BRIEF SUMMARY OF THE INVENTION

Generally, the disclosure discloses method and system of using mobile communication device, preferable mobile phone, to improve home safety. The principle behind the disclosed method and system is to use mobile communication device to intercept RF signal in electromagnetic (EM) spectrum suitable for remote control or remote sensing and interpret the received RF signal according to predetermined signal characteristics in order to identify source of the RF signal, then, to monitor progress of follow-up situation initiated by the RF signal and alert user for any potential safety concern raised up thereafter. If the mobile communication device is carried with user for most time of his/her daily activity, user could be immediately notified to act promptly to prevent a potential safety concern from evolving into a really occurred hazard or disaster. One example of such implementation is to prevent potential home fire danger for the situation that user turns on cooking range to cook but forgets to turn it off timely or prior to leaving home. Another example is to prevent unauthorized home entry through garage door that is unintentionally left open by user when user drives off away home but forgets to close the garage door through remote control.

In accordance with the invention, the method performed by a mobile communication device (MCD) is initiated by receiving a RF signal encoded with a predetermined data that represents a corresponding operation occurred remotely. The RF signal may be sent by any home appliance component that is built with appropriate capability to do so when a certain operation is performed on the home appliance with which the component is connected. The MCD contains a RF receiver capable of accepting RF signal within electromagnetic spectrum that is used for the component to send out the RF signal. The RF signal is then decoded to retrieve the predetermined data in order to identity the corresponding remote operation. After that, in accordance with the identified remote operation, if it is found to be the source that is under surveillance for safety concern, the MCD generates an event accordingly and initializes a Safety Watcher in accordance with the event. The safety watcher is an operation executed on the MCD either through hardware configuration or software codes running on its memory or mixing of both. The primary responsibility of the safety watcher is to monitor following development coupled with the event and, if certain condition is satisfied, raises up a safety warning to alert user about potential safety concern coupled with the event. In order to do that, the safety watcher closely monitor data that is considered to be crucial to detect potential safety hazard, for example a timer data that counts time after the event is generated, or a GPS (Global Positioning System) data indicating location of the MCD. Meanwhile, the MCD keeps alert for following incoming RF signal. When a following RF signal is received by the MCD, the RF signal is decoded accordingly to find out the corresponding remote operation and the remote operation decoded therefrom is analyzed whether it compliments with the original remote operation to form a completed open-close or On-Off operational cycle. For example, a following operation turning appliance off in conjunction with the initial operation turning appliance on are considered to complete an On-Off operation cycle If found true, the event generated from the original remote operation is cleared from potentially causing safety hazard and the safety watcher coupled with the event is cleared or terminated as well. In such case, no safety warning is given during the effective monitoring time interval of the safety watcher regarding to the event. However, if the open-close operational cycle is not found completed, the safety watcher will continue run on its duty. Whenever a certain safety warning condition is found met by the safety watcher running on monitoring, a safety warning is initiated by the safety watcher and user is prompted with corresponding warning message by the MCD through any applicable means, such as sound, flashing icon, vibration and so on.

In accordance with the invention, one scenario of the implementation of the method is to enhance home safety against fire hazard caused by ignorance of using cooking range. In this implementation, on-off switch knob of burner or cooking site embodies a control circuit comprising a RF transmitter and a position sensor capable of detecting position change of the knob, preferable OFF positioning of the knob. The knob with RF remote sensing capability facilitates implementation of the method by a Mobile Communication Device (MCD) for the purpose thereabove. When the knob is turned to its OFF position, the position sensor detects the operation and accordingly notifies control circuit to send out a RF signal encoded with predetermined data indicating the Off-To-On operation through the RF transmitter. The RF signal, may, in turn, be received by a mobile communication device in proximity and used for implementing the method in accordance with the invention to enhance safe use of cooking range. For this case, a safety watcher initiated by the MCD in response to the receiving of the RF signal may be a timer to count time thereafter or GPS positioning data that track potential movement of the user. If user leaves his/her home site or is out of a certain range from his home, a potential safety concern may be raised up to alert user that cooking range is still in use. When the knob of cooking range is turned from On to OFF position, the position sensor detects the operation and notifies the control circuit to send out a RF signal indicating the On-To-Off operation, which in turn may be received by the MCD and analyzed to clear off the safety watcher since a completed open-close operation cycle is found. If such open-close operational cycle is found met before the timer of safety watcher reaches a certain value, no safety warning is raised up to alert user. If the timer of safety watcher reaches a predetermined value without receiving any following RF signal that may be interpreted to complete the open-close operational cycle, a safety warning may be raised up to alert user to take care of this potential safety hazard related to the Overtime-On situation of cooking range.

In accordance with the invention, another scenario of the implementation of the method is to enhance home safety against unauthorized entry through opened garage door caused by ignorance of user. In one way of the implementation, a Mobile Communication Device (MCD) carried by the user implements the method as disclosed in accordance with the invention by intercepting RF signal sent by remote controls to garage door opener for opening and closing garage door. For the purpose, the MCD contains a RF receiver capable of receiving RF signals in EM spectrum used by remote controls of garage door opener. When a RF signal is sent by the remote control to garage door opener to open garage door, the MCD intercepts the RF signal and interprets it accordingly to generate an event coupled with the doo open operation. Then, a safety watcher is initiated to monitor following development of the situation. If within a certain time period, a following RF signal from one of the remote controls to garage door opener is not received by the MCD, a safety concern warning may be raised up by the MCD to alert user to respond accordingly. Or, if GPS positioning data under monitoring indicates user has left home without receiving the following RF signal, a safety concern warning may be raised up by the MCD to alert user that garage door may be left open. If the following RF signal is timely received, an open-close operational cycle is found completed and the event triggered by initial RF signal and corresponding safety watcher are cleared, no safety warning to be raised up. Another way of the implementation works similarly, but having a door position sensing device installed in coupling with door opener or with garage door to remotely notify CLOSE position of the garage door. For example, when door is opened, a RF signal indicating door position changes from CLOSE to OPEN is sent out by the door position sensing device. When door is closed, another RF signal indicating door position changes from OPEN to CLOSE is sent out by the door position sensing device. Accordingly, the MCD intercepts the RF signals to operate the safety monitoring process in accordance with the invention. Furthermore, another way of the implementation may have a door position sensing device installed and worked similarly but capable of detecting both CLOSE position and OPEN position of the garage door, therefore having more precise notification on status of the garage door.

In accordance with the invention, above description of summary is best effort to fulfill purpose or need of Brief Summary of Invention section and should not be used for purpose to reduce or be against merits of the invention as a whole. Furthermore, not to be limited by this summary section, all patentable rights embodied in or derived from the complete disclosure are reserved without prejudice.

### BRIEF DESCRIPTION OF THE SEVERAL VIEWS OF THE DRAWINGS

It should be understood that the brief description of the several views of the drawings is only for the purpose of presenting a concise reference to accompanying drawings and should not be inferred to have any suggestion to limit or reduce the scope of invention. Furthermore, the concepts and embodiments of the invention explicitly or implicitly shown in the drawings are only possibly understood accordingly by referring to following detailed descriptions upon illustrative showings of the drawings. For illustrative purpose, the drawings are not in scale. In the drawings:

FIG. 1 is a flowchart illustratively showing method of using mobile communication device to enhance home safety in accordance with the invention.

FIG. 2 is a bock diagram to illustratively show a circuit embodiment of the remote status sensing device for sending out RF signal reflecting status change detected thereby, which is useful for implementation of the method and system in accordance with the invention.

FIG. 3 illustratively shows a scenario of implementation of the method in accordance with the invention for safety enhancement of using cooking range.

FIGS. 4A and 4B are schematic showings of embodiments of the burner switch knob useful for the scenario as illustrated in FIG. 3, which embodies a control circuit comprising a position sensor and a RF transmitter, in accordance with the invention.

FIGS. 5A and 5B illustratively show a scenario of implementation of the method in accordance with the invention for safety enhancement of accessing automatic garage door, in which the mobile communication device (MCD) performing the method intercepts the RF signals sent by remote controls. Respectively, FIG. 5A illustrates the moment that garage door is opened by operating a wall-mounted remote control terminal or a vehicle mounted remote control when user is going to drive vehicle out of garage, and, FIG. 5B illustrates the moment that garage door is closed by operating a vehicle-mounted remote control after user drives vehicle out of garage.

FIGS. 6A and 6B illustratively show another scenario of implementation of the method in accordance with the invention for safety enhancement of accessing automatic garage door, similar as the scenario of the implementation as illustrated in FIGS. 5A and 5B, but using a remote position sensing device to send RF signal regarding operation of garage door. FIG. 6A illustrates a way of this implementation, in which the remote position sensing device is illustratively shown being installed on rail-moving slider of garage door opener to detect CLOSE position of garage door. FIG. 6B illustrates another way of this implementation having similar installation of the sensing device but capable of detecting both CLOSE position and OPEN position of garage door.

FIG. 7 illustratively shows another scenario of implementation of the method in accordance with the invention for safety enhancement of accessing automatic garage door, similar as the scenario of the implementation as illustrated in FIGS. 6A and 6B, but installing the remote position sensing device close to or coupled with garage door to detect CLOSE position of garage door.

FIG. 8 is a block diagram to illustratively show a hardware structure of mobile phone useful for performing the method to enhance home safety in accordance with the invention.

FIGS. 9A, 9B, and 9C are block diagrams to illustratively show several circuit embodiments of RF receiver module that may be embodied by mobile communication device for performing the method in accordance with the invention. FIG. 9A illustrates an embodiment of RF receiver module for receiving and decoding incoming RF signal. FIG. 9B illustrates another embodiment of RF receiving module that integrates RF receiving and decoding with a built-in timer. FIG. 9C illustrates another embodiment of RF receiving module that has a GPS receiver module integrated therewith.

### DETAILED DESCRIPTION

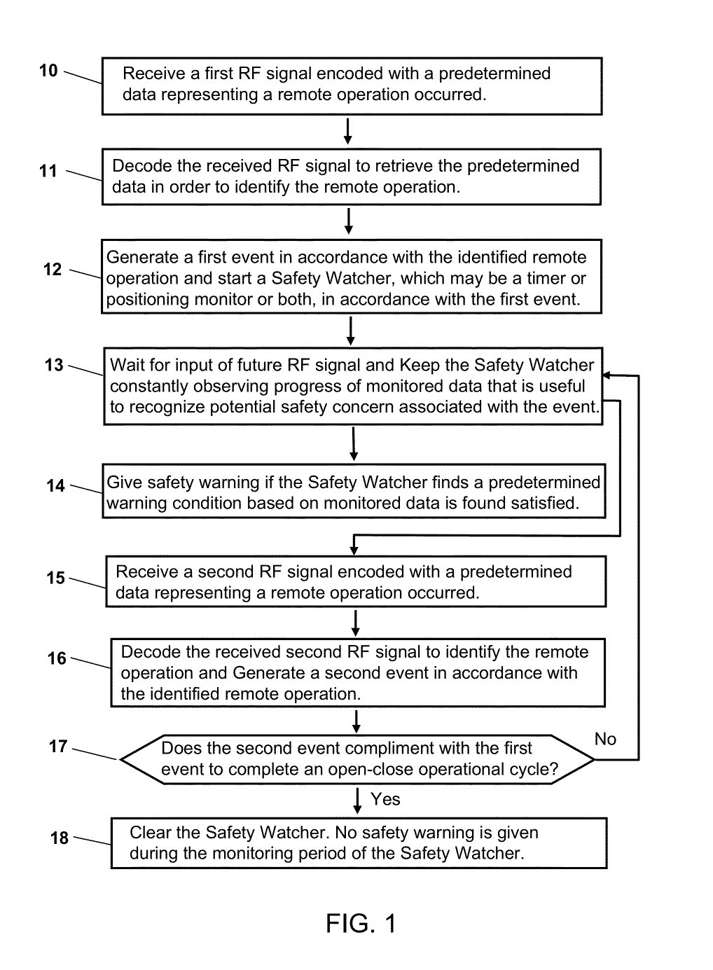

In accordance with the invention, the method of using mobile communication device (MCD) to enhance home safety is recognized more clearly by referring to the flowchart illustratively shown in FIG. 1. Accordingly as shown in Block 10 in FIG. 1, a first RF signal encoded with a predetermined data, which represents an operation on source of the RF signal occurred remotely, is received by the MCD. Then, as accordingly shown in Block 11, the received RF signal is decoded to retrieve the predetermined data in order for the MCD to identify the remote operation associated with the RF signal. The predetermined data is determined in certain form or structure that enables or facilitates to indentify the source that sends the RF signal and nature of operation occurred on the source, which in turn causes the source to send out the RF signal. The predetermined data has either itself or a correlated data form already stored on the MCD that permits MCD to perform identification of the remote operation associated therewith. After identifying the remote operation as starting certain operation on the source, as accordingly shown in Block 12, a first event in accordance with the indentified remote operation is generated by the MCD. Functionally, event is a general term referring to a record or recognition that an activity occurs. In implementation, the event may be a data code used by software codes for executing the method, or, a memory stored data or a circuit signal used by hardware infrastructure participating execution of the method. The first event triggers a monitoring process on follow-up situation on the remote operation that initiates the event. The monitoring process intends to find out potential safety hazard after the remote operation occurs. The fundamental of the monitoring process is to make sure user keeps clear awareness of going-on status on the source in order to prevent an operation on the source subsequently ignored by user from evolving into a really occurred safety danger or disaster. For performing the monitoring process, the MCD starts a Safety Watcher associated with the first event. The safety watcher may be implemented by the MCD through software codes or instructions that is executed on processor or processors of the MCD, or, hardware structure connected to main processor unit of the MCD through communication interface, or mixed uses of both. For software implementation, the safety watcher is sequences of processor operable codes or instructions residing in the MCD that, under operation, keeps examining data under monitored in order to decide whether a certain condition predetermined for the data is satisfied and, if the condition is satisfied, raises up notification accordingly. For hardware implementation, the logic of monitoring process is performed by circuits of involved hardware structures. For mixed implementation, the monitoring process is collectively performed by partially through software codes and partially through control logics of hardware circuits. One example of the safety watcher is a timer to count time elapsed and keeps observing whether a predetermined time value is reached by the timer in order to raise up time-over warning for potential safety concern. Another example of the safety watcher is a GPS positioning monitor that constantly observes positioning data from GPS module coupled with or contained by the MCD and raise up warning for potential safety concern when the positioning data indicates user is leaving site of source under safety monitored. Another example of the safety watcher comprises both timer and GPS positioning monitor to observe both time-over condition and leaving-site condition for better and more reliable performance. After that, as accordingly shown in Block 13, the MCD waits for possible incoming RF signal while keeping the safety watch constantly observing progress of monitored data that is useful to recognize potential safety concern associated with the first event. If a predetermined warning condition based on monitored data is found satisfied by the safety watch, as accordingly shown in Block 14, the safety watcher raises up notification to MCD and, accordingly, MCD gives an alert regarding to the satisfied warning condition to user through any applicable means for reminding, for example, audio sound, voice reminder, icon on display, vibration, and so on. If a second RF signal encoded with a predetermined data representing a remote operation occurred is received before the warning condition is found satisfied, as accordingly shown in Block 15, the MCD should take necessary procedure to determine whether the second RF signal indicates an open-close operational cycle is completed. To do so, as accordingly shown in Block 16, the received second RF signal is decoded to identify the remote operation with which the second RF signal is associated. Once identifying the source and nature of the remote operation associated with the second RF signal, a second event in accordance with the identified remote operation is generated by the MCD for further verification. Then, as accordingly shown in Block 17, the MCD will compare the second event with the first event to see whether the second event compliments with the first event to satisfy a completed open-close operational cycle. The open-close operational cycle means completing use of an apparatus from start to end, during which certain purpose of using the apparatus is accomplished upon nature of the use. If it is not found to fulfill a completed open-close operational cycle, the safety watch continues to run monitoring, as accordingly shown in Block 17 right branch going from Block 17 back to Block 13. If it is found to fulfill a completed open-close operational cycle, as accordingly shown in Block 18, the safety watcher associated with the first event is cleared off. The monitoring process initiated by the first event is considered fulfilled or terminated. No safety warning is given during the monitoring process of the safety watcher. The process may be repeated over and over to provide constant safety guard on purpose thereof.

Depending upon need of real situation, the second event may be used to initiate another safety watcher for monitoring a new issue no matter whether it compliments with the first event. Depending upon need of real situation, the second event may be considered to fulfill one stage of a multi-stage monitoring process, in which, either the first event or the second event may become initializing event for following stage of the monitoring process and the similar monitoring process is performed for the following stage.

Generally, system to facilitate implementation of the method in accordance with the invention comprises a remote status sensing device, coupled with an apparatus wanted to be cautiously observed for potential safety concern, capable of sending RF signal reflecting status change sensed by the device, a mobile communication device (MCD), preferable a mobile phone, capable of receiving RF signal in EM frequency spectrum in which RF signal from the remote status sensing device is transmitted. In cooperation, the status sensing device detects a start of operation performed on the apparatus under safety observation and sends out a corresponding RF signal to signify the status change. As disclosed above, the MCD in nearby region intercepts the RF signal and interprets the RF signal accordingly to start the monitoring process. Following that, when the status sensing device detects an end of operation performed on the apparatus, it sends out another corresponding RF to signify the status change. By intercepting the RF signal and processing it accordingly, the MCD completes the monitoring process without raising up safety warning to user. If no following RF signal indicating the end of the operation is received, the monitoring process may raise up a safety warning to user when certain condition is met. Because a mobile phone is typically carried by user for most time of daily activities, thus having more chance to be present nearby apparatus under safety observation when user operates the apparatus, it is preferred for implementing the method to enhance home safety in accordance with the invention. Depending on case, the status sensing device may be a dedicated device designed for the purpose thereof or an existing device made for its own use but also capable of sending RF signal to indicate its status change, for example RF remote control. The interaction between the status sensing device and the MCD is through transmitting and receiving RF signal. Thus, the process performed by the MCD will not be affected by how the device transmitting RF signal is made.

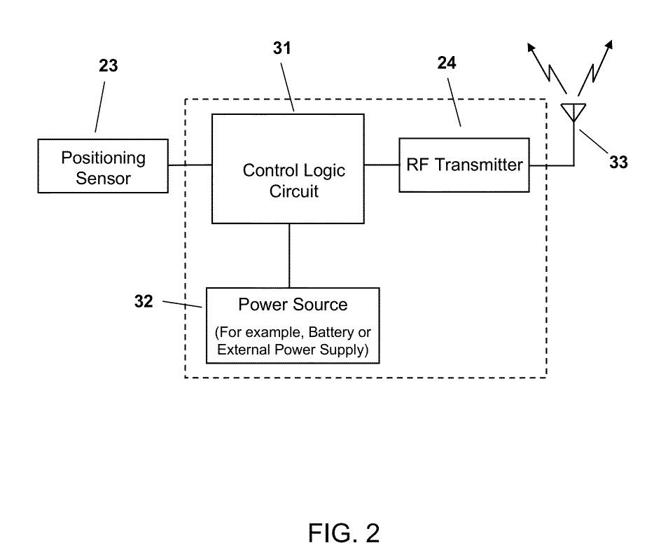

A circuit embodiment for the remote status sensing device, useful for implementation of the method and system in accordance with the invention, is illustratively shown by the block diagram in FIG. 2. The circuit embodiment comprises a positioning sensor 23, a RF transmitter 24, and a control logic circuit 31 connected therewith. Control logic circuit 31 reads output signal from sensor 23. Positioning sensor 23 is normally installed in coupling with ON or OFF of the apparatus under supervised for safety concern. So, status change from OFF to ON or ON to OFF on the apparatus can be sensed by the sensor. When the output signal from sensor 23 changes, circuit 31 determines whether status change is detected and, if so, directs RF transmitter 24 to send out RF signal corresponding to the status change. To facilitate RF signal emission, an antenna 33 is connected to RF transmitter 24. The circuit embodiment is powered up by a power source 32, which may be a battery or external power supply. To make the device in real environment, circuit 31 and transmitter 24 may be placed on one printed circuit board (PCB). Power source 32 is connected to the PCB. If battery is used for power source 32, it may be placed on the PCB as well. Normally, upon frequency of transmitted RF signal, antenna 33 may or may not be placed on the PCB. It should be recognized that, the whole circuitry for the circuit embodiment may be integratedly produced on single chip using state-of-art semiconductor fabrication and integration techniques.

An example of implementing the method and system using mobile communication device to enhance home safety of using cooking range is provided following, in accordance with the invention.

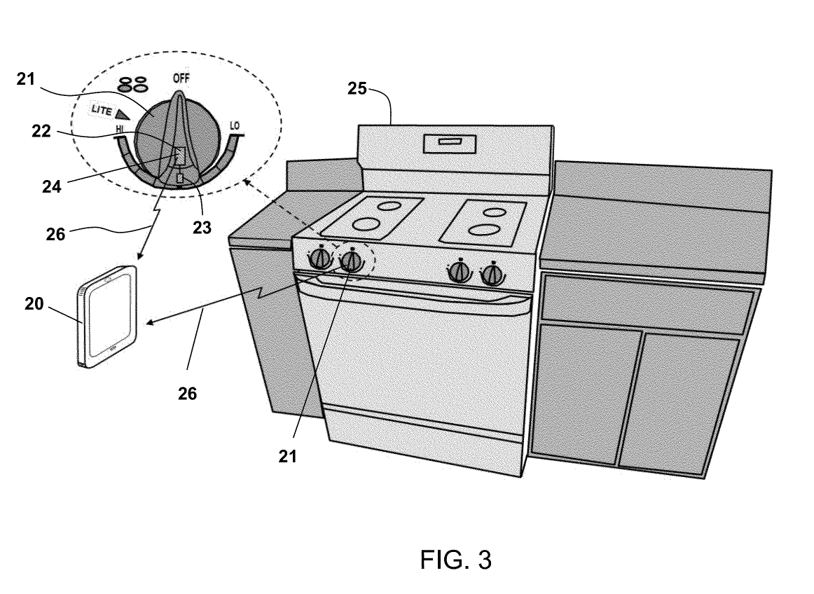

In the example, burner switch knob of cooking range is turned into a remote status sensing device. The burner switch knob can have any outside shape for its body to be like ordinary knob, which is usually desired to be comfortable for hand use and look stylish. What differentiate the burner switch knob from ordinary switch knob is that it embodies a control circuit comprising a position sensor capable of detecting OFF position of the knob and a RF transmitter to send out RF signal indicating status change of the position sensor. In cooperation with a MCD, the control circuit sends RF signal for receiving by the MCD that carries on the method for safety monitoring. In such way, the knob acts as remote status sensing device. The knob in conjunction with the MCD form a system to implement the safety enhancement in accordance with the invention. By making the body of the burner switch exchangeable with an ordinary switch knob, such safety enhancement feature can be readily deployed on existing cooking range or cooking range without special design consideration by simply replacing the ordinary switch knob with the knob embodying the control circuit. Furthermore, adding such safety enhancement feature at design phase of new cooking range presents no or little challenge because the knob embodying the control circuit is self-contained and does not require intervention from central control of cooking range. The implementation scenario of the example is recognized more clearly by referring to illustratively showing of the drawing of FIG. 3.

As illustratively shown in the drawing of FIG. 3, a cooking range 25 has a burner switch knob 21 installed to control burner of the range. As shown in enlarged view section, knob 21 embodies a control circuit 22, which comprises a position sensor 23 and a RF transmitter 24. Position sensor 23 is preferred to be placed along central vertical line of the installed knob that passes through OFF position of switching. As shown in the drawing, position sensor 23 is placed at lower end of the central vertical line near edge of the body of the knob, which is a preferred location to place the sensor. Alternatively, position sensor 23 may be placed near upper end of the central vertical line, which is also a preferred location to place the sensor. It should be recognized that the position sensor may be placed at any location on or close to underneath surface of the body of the knob if rotating the knob from OFF position causes the reading of the sensor changes accordingly and sufficiently to detect such status change. If the knob is turned away from the OFF position, sensor 23 is moved off the central line accordingly, thus capable of detecting the OFF position. Position sensor 23 may be a mechanical switch sensor that is ON or OFF when a mechanical switch contained by the sensor is pushed contact or is open. Accordingly to make mechanical switch sensor work, a stopper to trigger the sensor may be installed around OFF position on the panel underneath the sensor. Alternatively, position sensor 23 may be a proximity sensor that sense presence of a sensing field to indicate its status. Accordingly to make the proximity sensor work better, a very small sensing plate to trigger the sensing may be installed around OFF position on the panel underneath the sensor. For example, a small plate of magnet may be installed in the way to work with a magnetic proximity sensor such as a Hall effect sensor or other magnetic sensor. If a IR proximity sensor is used, the sensing plate may have a light reflective coating or layer on its top surface to facilitate light reflecting back to the sensor. For operation of safety enhancement, control circuit 22 sends out a RF signal 26 through RF transmitter 24 when position sensor 23 detects the knob rotating away from OFF position. The RF signal is encoded with predetermined data that allows its recipient to identify a remote operation turning on burner of cooking range occurred. A mobile phone 20 nearby receives RF signal 26 and performs the method for safety enhancement accordingly. In the scenario, operation of turning knob 21 from OFF position to ON position will cause the MCD, upon receiving the corresponding RF signal, starts a safety watcher on that. To ensure user not forgetting to turn off the burner, a timer may be included by the safety watcher that will count time elapsed after starting. When a certain time value is reached by the timer, the safety watcher raises up a warning to user that the burner of cooking range is still on. To ensure user not leaving home while the burner of cooking range is still on, a GPS positioning monitor may be included by the safety watcher that constantly measures position data of the cell phone. If positioning data shows it is away from home by a certain distance, the safety watcher raises a warning to user that the burner of cooking range is left on. If analysis on positioning data indicates it is moving at a speed above a certain level that is not likely normal walk speed, a safety warning may be raised up by the safety watcher as well since the user is very likely running away or driving off the home. When knob 21 is turned back to OFF position, another RF signal is sent out by control circuit 22 accordingly to indicate the burner is OFF. Upon receiving the RF signal, the MCD monitoring the situation could be aware that the burner is off and corresponding safety watcher can be cleared off.

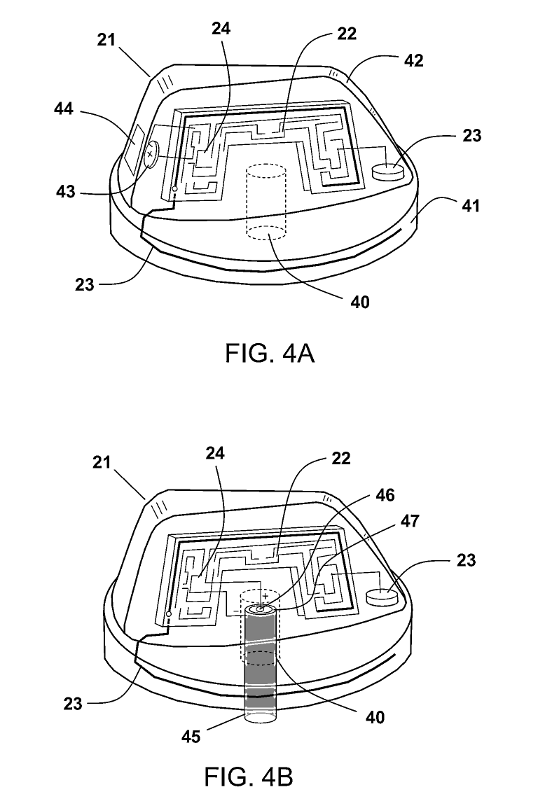

Control circuit 22, which acts as the remote position sensing device for the purpose described above, may use circuit embodiment as illustratively shown in FIG. 2. Control circuit 22 may use battery or external power source as power supply to operate. When battery is used, the battery can be placed inside the body of knob 21. Depending upon internal volume available, button type battery may have to be used in order to be placed inside the body. When external power source is used, connection from the external power source to inside circuit 22 may have to be arranged properly to ensure reliable connection and ease installation. Two embodiments of knob 21 are illustratively shown in schematic drawings of FIGS. 4A and 4B respectively.

As illustratively shown in the schematic drawing of FIG. 4A, an embodiment of knob 21 uses battery 43 placed inside the body of the knob to power up control circuit 22. The body of knob comprises a base portion 41, which is like disc shape, and a handle portion 42, which is extruded above the base portion for hand holding. A detachable cover 44 on outer surface of the body next to the battery may be opened for replacing the battery. Control circuit 22 is made on printed circuit board (PCB) except position sensor 23 is placed outside near bottom surface of base portion 41 of knob 21. Sensor 23 and battery 44 are both connected to the PCB. Antenna 23 is curled inside base portion 41 of knob 21 and one-end connected to circuit portion on the PCB that corresponds to RF transmitter 24. The PCB containing majority of control circuit 22 is placed vertically inside handle portion 42 of knob 21 to maximize using of internal volume of the knob. To install the knob on equipment, a center hole 40 allows a cylinder post extruded from control panel of equipment to be accommodated inside the hole and fixed thereafter.

To use external power supply for control circuit 22 embodied by knob 21, a power line connection should be made from external power supply to the circuit. There are a variety of ways to do that. One way to do the connection is illustratively shown by the embodiment as illustratively shown in the drawing of FIG. 4B. In the showing of the embodiment, no battery is present comparing with the embodiment as illustratively shown in the drawing of FIG. 4A. Instead, power line connection with external power supply is illustrated. When the knob is installed on a cylinder post 45, which is extruded from control panel of equipment (not shown), one connection line, for example for positive voltage, is made through a conductive core 46 of post 45, and the other connection line, in the example for ground of voltage, is made through outer conductive surface 47 of post 45. On the other end of post inside the control panel, core 46 and outer surface 47 are respectively connected to output lines of power supply (not shown). There is electrical insulation between core 46 and outer surface 47 to prevent short-circuit. To make the post, one way is to use a hollow metal cylinder post as the outer conductive surface and passes through an insulated conduction wire as the conductive core. A more complex way is to make a solid cylinder post with multi layers of, ranging from center to outer surface, conductive core, insulation layer and conductive surface layer. In the embodiment, when the knob is installed on the post, connection to external power surface is accomplished accompanying the installation.

Another example of implementing the method and system using mobile communication device to enhance home safety of accessing garage door is provided following, in accordance with the invention.

In the example, scenario is to prevent driver drives car out of garage and leaves home without closing garage door. The left-open garage door renders home a security hole for unauthorized entry, and potentially have more chances to draw attentions of passing-by criminal. With the implementation, driver carrying a mobile phone may be alerted by the mobile phone that the garage door is left open. The example may be understood more clearly by referring to following scenarios.

The first scenario for the example, as illustratively shown in the drawings of

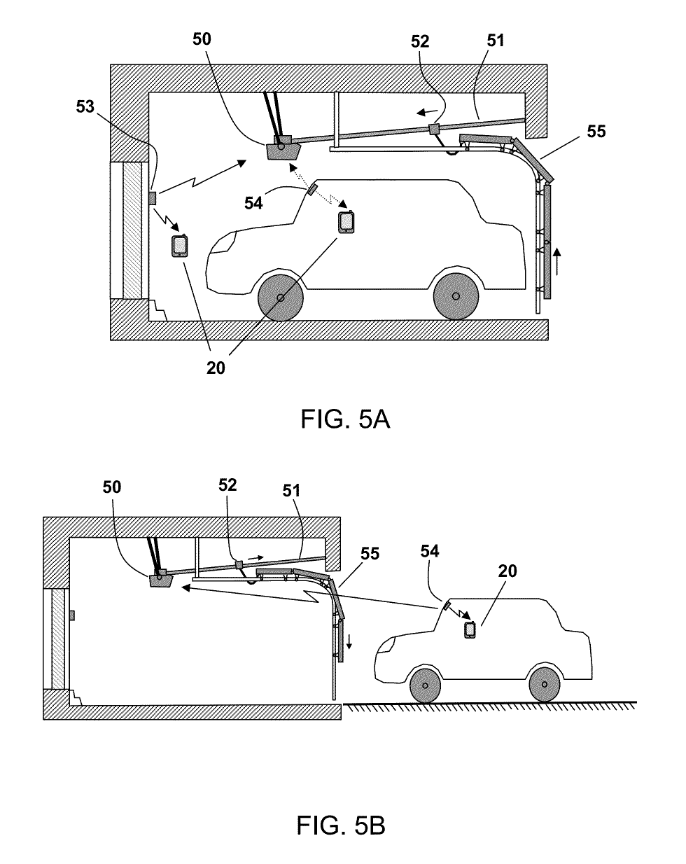

FIGS. 5A and 5B, assumes automatic garage door opener is installed on site to operate garage door. As shown in the drawings, garage door opener 50 is installed above on ceiling of garage. The garage opener drives a movable slider 52 to move along a rail 51 to open or close garage door 55. Garage door opener 50 receives RF signal sent by remote control to operate. Typically, a remote control terminal 53 is installed on wall next to entrance door to interior of home for user to open or close garage door when exiting or entering home. Another remote control 54 is mounted on vehicle that parks inside garage. To implement the method to enhance home safety in accordance with the invention, mobile phone 20 carried by user is used to intercept RF signals sent from remote controls to opener 50 and uses the intercepted RF signal to start monitoring process as described above in this disclosure. As illustrated in the drawing of FIG. 5A, when user (driver as well) is going to drive vehicle out of garage to leave, he or she may press either wall-mounted remote control terminal 53 or vehicle-mounted remote control 54 to signal opener 50 to open door 55. The RF signal for the remote operation is accepted by mobile phone 20 in proximity. Then, mobile phone 20 interprets the received RF signal to determine a door open operation occurred and starts a safety watcher accordingly. As illustrated in the drawing of FIG. 5B, after user drives vehicle out of garage and subsequently presses vehicle-mounted remote control 54 to signal opener 50 to close door 55. The RF signal is accepted by mobile phone 20 onboard vehicle with user. Then, mobile phone 20 may recognize a door close operation occurred and clear the safety watcher accordingly. However, if user forgets to press remote control 54 to close door 55 and drives away from home, the safety watcher may give warning to alert user that garage door may be left open. Either a timer to count time elapsed or a GPS positioning monitor or both may be used by the safety watcher to detected user's ignorance. For example, the safety watcher may gives warning one minute later if not receiving RF signal associated with door close operation. For another example, the safety watcher may give warning if GPS positioning data indicates user has left home by analyzing either distance or speed. For another example, both timer and GPS positioning are used by the safety watcher to have better performance. In another example, the safety watcher may give warning repeatedly at certain time interval once it starts, which is analogues to using a timer but setting timed value as zero. In such extreme case, the repeated warning may be stopped by receiving RF signal of door close operation or by user's intervention. When user drives vehicle back home and parks vehicle inside garage, a vice-versus process may be conducted to enhance home safety too.

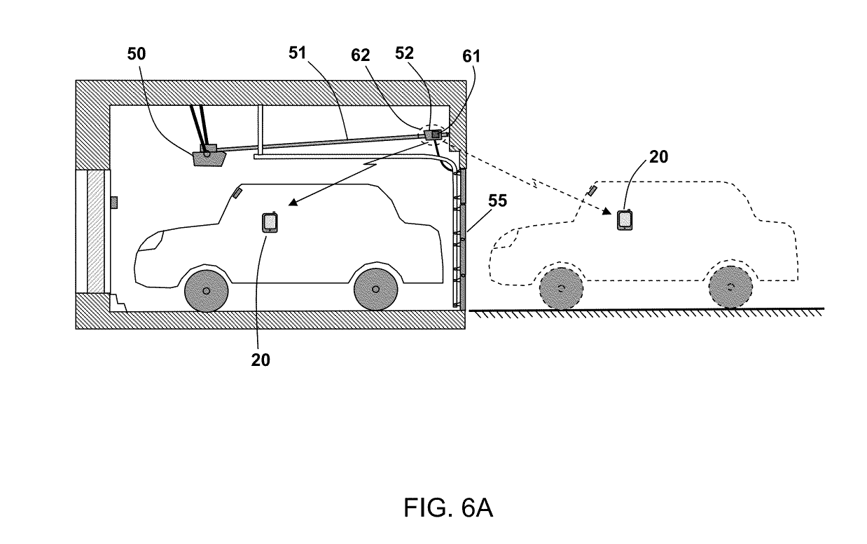

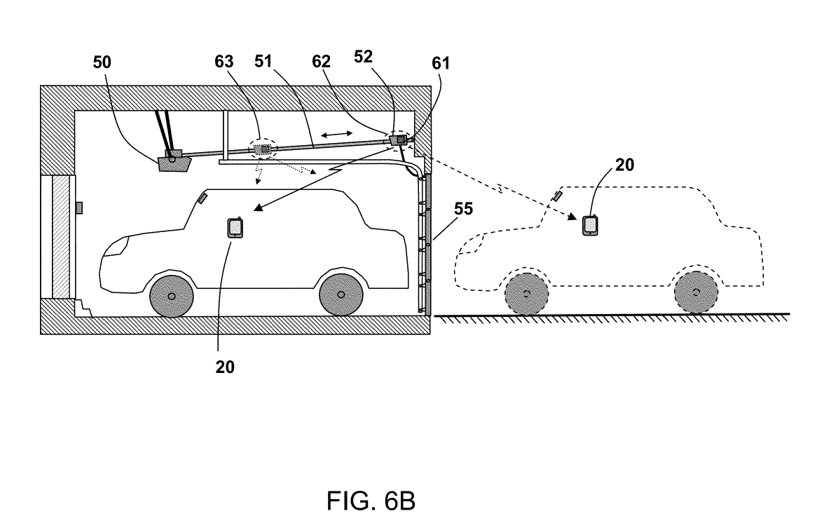

The second scenario for the example, as illustratively shown in the drawings of FIGS. 6A and 6B, is similar as the first scenario in term of procedure for implementation of home safety enhancement, but using a remote position sensing device 61 mounted on moving slider 52 to detect OFF position 62 of the slider on rail 51 that corresponds to close position of garage door 55. In this case, RF signal from device 61 is to be accepted and used by mobile phone 20 for monitoring process. This approach of using remote position sensing device makes the procedure for safety enhancement more reliable and consistent since the implementation is less dependent on remote control of garage opener. Installing device 61 could also be done easily by attaching the device on slider 52. A sensing marker or plate may be placed at OFF position on rail 51 to make the device more sensitive and reliable. Alternatively, device 61 may be mounted on rail 51 at OFF position, which is not preferred to mounting on slider 52. When slider 52 moves away from OFF position 62, device 61 detects the leaving and sends out corresponding RF signal, which corresponds to user opens garage door. When slider 52 arrives at OFF position 62, device 61 detects the arrival and sends out corresponding RF signal, which corresponds to user closes garage door. Furthermore, as illustratively shown in the drawing of FIG. 6B, remote position sensing device 61 is mounted on slider 52 and works to send our RF signals respectively at both close and open positions on rail 51 that corresponds to door close and door open. So, mobile phone 20 to implement the method of safety enhancement may obtain more information about door status and may provide alert more accurately and reliably. To enable device 61 to achieve that, it can be done by mounting another sensing marker or plate at Open position 63 on the rail, which triggers the device when slider 52 moves to open position 63.

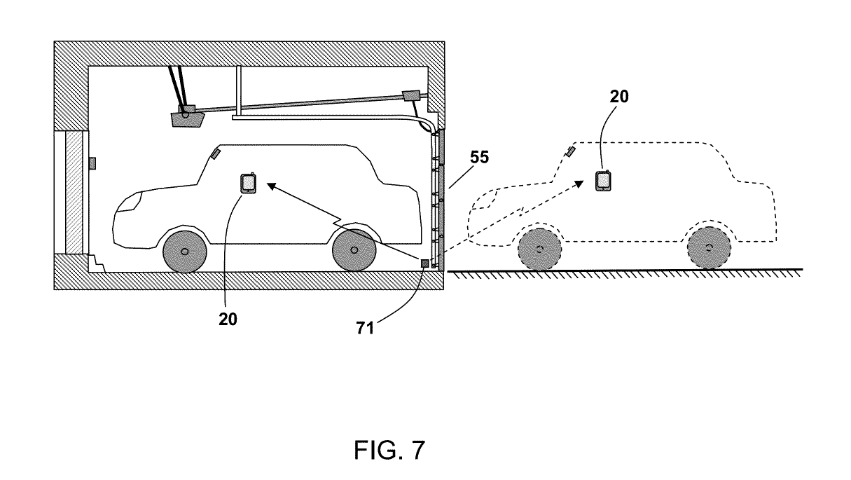

The third scenario does not assume automatic garage door opener is installed on site. As illustratively shown in the drawing of FIG. 7, a remote position sensing device 71 is mounted next to close position of garage door 55 in such way the opening door and closing door trigger the device to send out corresponding RF signals intended to be received by mobile phone 20 to implement the method of safety enhancement. Alternatively, device 71 may be mounted on door 55 near its lower edge to detect door closed. Device 71 may also be mounted next to the rail holding movement of the garage door so that the device is triggered when door 55 moves into close position. When user is going to drive vehicle out, device 71 detects opening operation of garage door and sends corresponding RF signal to signify mobile phone 20 to start the monitoring process. After user drives vehicle out of garage, device 71 detects closing operation of garage door and sends corresponding RF signal to signify mobile phone 20 that door is closed. If user forgets to close door and drive away, mobile phone 20 implementing the method of safety enhancement may give warning to alert user. This scenario of implementation is preferable to the second scenario for relatively easier installation of the remote position sensing device.

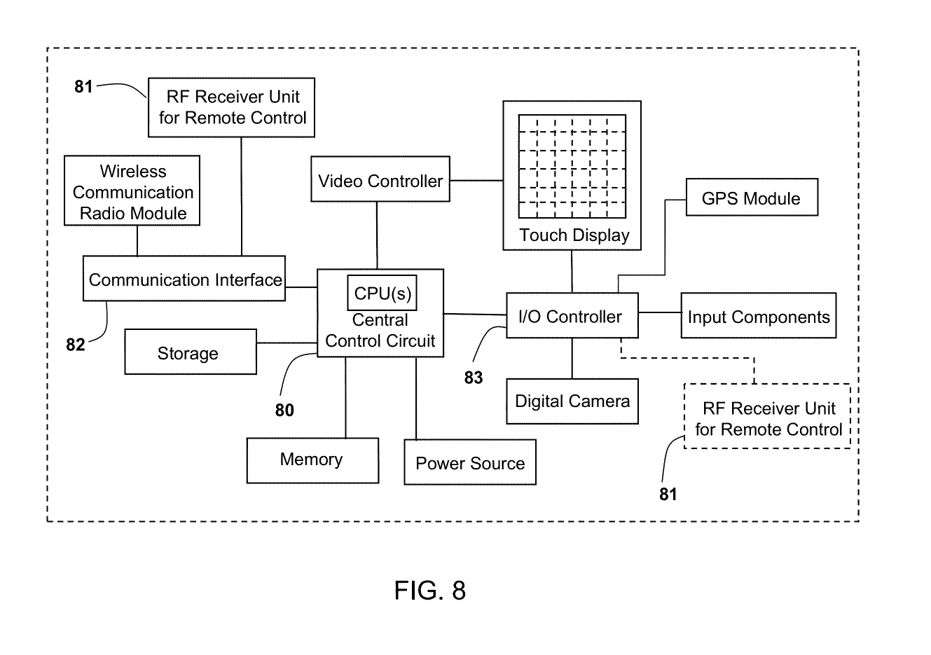

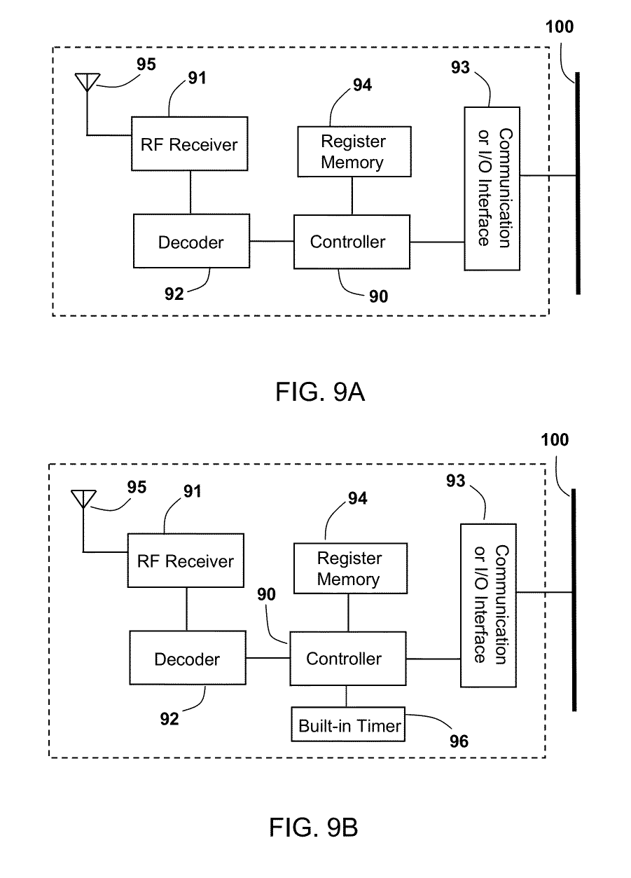

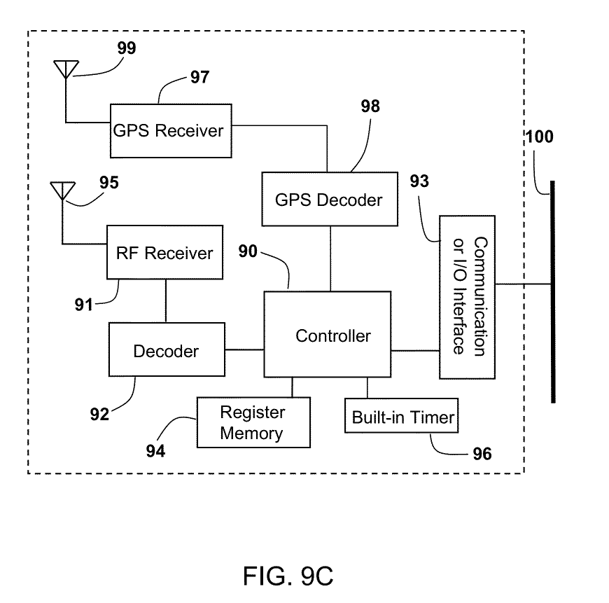

Normally, RF signal sent for remote control or remote sensing may be allocated to a different EM frequency from wireless communication used by mobile communication device. In order to accept the RF signal sent for remote control or remote sensing, it may require mobile communication device to contain a separate RF receiver module dedicated for the purpose. Using a dedicated RF receiver module for the purpose may avoid interfering communication traffic on wireless communication network and ensure reliable interception of RF signal for remote control or remote sensing. The dedicated RF receiver module may be added to hardware structure of mobile communication device either as an internal component or as an external plug-in card. For example, FIG. 8 illustratively gives a block diagram of hardware infrastructure of a mobile phone. As illustrated in the drawing, a dedicated RF receiver module 81 for remote control may be a component connected on internal communication interface 82. Or, the dedicated RF receiver module for remote control may be an external card plugged into external I/O port to connect onto I/O interface 83. The operation of the RF receiver module may be configured and coordinated by central control circuit 80. FIGS. 9A, 9B, 9C gives several examples of circuit block diagram of the RF receiver module for remote control or sensing.

As illustratively shown in the drawing of FIG. 9A, one example of circuit block diagram of the RF receiver module for remote control and sensing comprises a RF receiver 91, a controller 90, a decoder 92 connected with the RF receiver and the controller, a communication or I/O interface 93 connected with the controller, and a register memory 94 connected to the controller. An antenna 95 may be connected to the RF receiver. In installation, communication interface 93 is connected to communication bus 100 of the mobile communication device. In operation, RF receiver 91 accepts RF signal and passes the signal to decode 92 for decoding. The data retrieved is then conveyed to controller 90. Controller 90 may use the data stored in register memory 94 to perform preliminary processing on the data encoded. Then, controller 90 communicates, through communication interface 93 and communication bus 100, to central control circuit (CPU) of mobile communication device on which the RF receiver module is installed. Another example as illustratively shown in the drawing of FIG. 9B further comprises a built-in timer 96 connected to controller 90. With built-in timer 96, some function of safety watcher related to time counting as described above in the disclosure may be allocated to the controller to perform. Another example as illustratively shown in the drawing of FIG. 9C further comprises a GPS module comprising a GPS receiver 97 and a GPS decoder 98 connected to receiver 97 and controller 90. The GPS module may further comprises an antenna 99 connected to receiver 97. The GPS module sends GPS positioning data to controller 90. With both built-in timer 96 and the GPS module onboard, the controller can carry out function of safety watcher as descried above in the disclosure with less reliance upon processor resource of the mobile communication device (MCD), thus making it respond much faster and more responsive. With such capability, codes or instructions executed on processor of the MCD take less burden to handle the safety watcher, thus executing better in multi process environment of operating system. This approach is mixing of hardware and software implementations for the method to enhance home safety in accordance with the invention.

It should be understood that embodiments disclosed are only a few examples of possible implementations of the invention disclosed in the disclosure and their teachings may be used by ordinary skilled in related art to modify the embodiments or derive from the embodiments to form embodiment appearing not similar as the embodiments but still utilizing true merit and teaching spirit of the invention. Therefore, if any, the modification or derivation is still within the scope of the invention and all related rights are reserved.

I claim:

1. A method performed by a mobile communication device comprising:
receiving a first RF signal encoded with a predetermined data associated with a first remote operation that causes said first RF signal to be sent out;
decoding said first RF signal to retrieve said predetermined data;
generating a first event in accordance with said predetermined data; and, effecting a safety watcher related to said first event to monitor data that facilitates recognition of a safety concern following said first event.

2. The method in accordance with claim 1 further comprising a step of:
giving an alert regarding said safety concern that is recognized by said safety watcher.

3. The method in accordance with claim 1 further comprising:
receiving a second RF signal encoded with a predetermined data associated with a second remote operation that causes said second RF signal to be sent out;
decoding said second RF signal to retrieve said predetermined data associated with said second remote operation;
generating a second event in accordance with said predetermined data associated with said second remote operation;
finding said second event complimenting said first event to complete an ON-OFF operational cycle; and,
putting said safety watcher ineffective.

4. The method in accordance with claim 1 wherein said safety watcher comprises a timer to observe time data.

5. The method in accordance with claim 1 wherein said safety watcher comprises a GPS positioning monitor to observe location data.

6. The method in accordance with claim 1 wherein said safety watcher comprises a timer to monitor time data and a GPS positioning monitor to monitor location data.

7. The method in accordance with claim 1 wherein said first RF signal is sent out by a remote status sensing device comprising a position sensor and a RF transmitter, whereby, in operation, said device detects said first remote operation with said position sensor and sends out said first RF signal with said RF transmitter.

8. The method in accordance with claim 1 wherein said first RF signal is sent out by a burner switch knob embodying a control circuit comprising a position sensor and a RF transmitter, whereby, in operation, said control circuit detects said first remote operation with said position sensor and sends out said first RF signal with said RF transmitter.

9. The method in accordance with claim 1 wherein said first RF signal is sent out by a remote control of a garage door opener.

10. A non-transitory computer-readable medium having sequences of instruction stored thereon, the sequences of instructions includes instructions which, when executed by a mobile communication device, causes the mobile communication device to perform operations comprising the steps of:
receiving a first RF signal encoded with a predetermined data associated with a first remote operation that causes said first RF signal to be sent out;
decoding said first RF signal to retrieve said predetermined data;
generating a first event in accordance with said predetermined data; and,
effecting a safety watcher related to said first event to monitor data that facilitates recognition of a safety concern following said first event.

11. The non-transitory computer-readable medium of claim 10 wherein said operations further comprises the step of:
giving an alert regarding said safety concern that is recognized by said safety watcher.

12. The non-transitory computer-readable medium of claim 10 wherein said operations further comprises the steps of:
receiving a second RF signal encoded with a predetermined data associated with a second remote operation that causes said second RF signal to be sent out;
decoding said second RF signal to retrieve said predetermined data associated with said second remote operation;
generating a second event in accordance with said predetermined data associated with said second remote operation;
finding said second event complimenting said first event to complete an ON-OFF operational cycle; and,
putting said safety watcher ineffective.

13. The non-transitory computer-readable medium of claim 10 wherein said safety watcher comprises a timer to observe time data.

14. The non-transitory computer-readable medium of claim 10 wherein said safety watcher comprises a GPS positioning monitor to observe location data.

15. The non-transitory computer-readable medium of claim 10 wherein said first RF signal is sent out by a remote status sensing device comprising a position sensor and a RF transmitter, whereby, in operation, said device detects said first remote operation with said position sensor and sends out said first RF signal with said RF transmitter.

16. The non-transitory computer-readable medium of claim 10 wherein said first RF signal is sent out by a burner switch knob embodying a control circuit comprising a position sensor and a RF transmitter, whereby, in operation, said control circuit detects said first remote operation with said position sensor and sends out said first RF signal with said RF transmitter.

17. The non-transitory computer-readable medium of claim 10 wherein said first RF signal is sent out by a remote control of a garage door opener.

18. A burner switch knob useful for control of a cooking apparatus embodying a control circuit comprising a position sensor and a RF transmitter, whereby, in operation, said control circuit detects a position change of the knob with said position sensor and sends out a RF signal in accordance with said position change with said RF transmitter.

19. The burner switch knob in accordance with claim 18 wherein said control circuit further comprises a battery to power operation of said control circuit.

20. The burner switch knob in accordance with claim 18 wherein said position sensor is a magnetic proximity sensor.
